(19) United States
(12) Patent Application Publication
(10) Pub. No.: US 2026/0016334 A1
(43) Pub. Date: Jan. 15, 2026

(54) METHOD FOR ADAPTING AN APERTURE GEOMETRY OF AN APERTURE OF AN APERTURE DIAPHRAGM TO A BEAM PATH OF LIGHT BEAMS IN A SPECTROMETER

(71) Applicant: Analytik Jena GmbH+Co. KG, Jena (DE)

(72) Inventors: Stefan Münch, Berlin (DE); Michael Okruss, Potsdam (DE); Marco Braun, Jena (DE)

(21) Appl. No.: 19/262,387

(22) Filed: Jul. 8, 2025

(30) Foreign Application Priority Data
Jul. 15, 2024 (DE) 10 2024 120 014.6

(51) Int. Cl. G01J 3/02; G01J 3/42; G01J 3/443

(52) U.S. Cl. CPC G01J 3/0237; G01J 3/0208; G01J 3/0229; G01J 3/42; G01J 3/443

(57) ABSTRACT

A method for adapting an aperture geometry of an aperture of an aperture diaphragm to a beam path of light beams in a spectrometer, wherein the spectrometer comprises the aperture diaphragm, a plurality of optical components and a detector, includes providing an optical model that describes the beam path and comprises the optical components as well as their positions and orientations, establishing a quality function that describes at least one quality criterion of the beam path, wherein the quality function calculates a quality measure based on the optical model, providing a position of the aperture diaphragm and a maximum area of the aperture in the optical model, wherein the maximum area is composed of a plurality of subapertures, calculating a quality measure for each subaperture by means of the quality function, and determining the aperture geometry based on the quality measures of the subapertures.

### CROSS-REFERENCE TO RELATED APPLICATION

The present application is related to and claims the priority benefit of German Patent Application No. 10 2024 120 014.6, filed Jul. 15, 2024, the entire contents of which are incorporated herein by reference.

### TECHNICAL FIELD

The present disclosure relates to a method for adapting an aperture geometry of an aperture of an aperture diaphragm to a beam path of light beams in a spectrometer, wherein the spectrometer comprises the aperture diaphragm, a plurality of optical components and a detector, wherein the optical components are arranged and embodied in such a manner that they lead the beam path of the light beams from a light source to the detector, wherein the detector is embodied to detect the light beams in the form of a spectrum. The present disclosure relates further to a method for producing an aperture diaphragm, whose aperture geometry is adapted to a beam path of light beams in a spectrometer, and to a spectrometer comprising a plurality of optical components, a detector and an aperture diaphragm.

### BACKGROUND

Aperture diaphragms are regularly applied in spectrometers, in order to establish the beam geometry of the light beams, in that they let a part of the light beams pass to the subsequent beam path and block another part. For this, they have an, often black, frame area with an aperture, through which the light beams can pass. The aperture can have different aperture geometries. Conventional aperture geometries have, for example, circular, elliptical or rectangular forms. Aperture diaphragms are frequently arranged before an entrance slit of the spectrometer, i.e. at a point, where the light beams are not yet spectrally separated. They can, however, also be arranged at other positions of the beam path. Since the aperture diaphragm determines the beam geometry of the light beams, it contributes to a high degree to the determining of the geometric light throughput (etendue) of the spectrometer. Additionally, the aperture diaphragm determines together with the focal length of the imaging system the aperture ratio of the system and has a large influence on image defects. By choice of the aperture diaphragm and, especially, the aperture geometry, thus, different spectrometer characteristics can be greatly influenced. The conventional aperture geometries are, however, regularly not suitable for the beam path present in the spectrometer, such that the advantages of the aperture diaphragm as regards image defects, among others, cannot be optimally utilized.

### SUMMARY

An object of the present disclosure is, consequently, to provide a method and a spectrometer enabling an adapting of an aperture geometry to a beam path.

The object is achieved according to the present disclosure by a method for adapting an aperture geometry of an aperture of an aperture diaphragm to a beam path of light beams in a spectrometer as claimed in claim 1, a method for producing an aperture diaphragm as claimed in claim 14 and a spectrometer as claimed in claim 15.

According to the present disclosure, the object is achieved by a method for adapting an aperture geometry of an aperture of an aperture diaphragm to a beam path of light beams in a spectrometer, wherein the spectrometer comprises the aperture diaphragm, a plurality of optical components and a detector, wherein the optical components are arranged and embodied in such a manner that they lead the beam path of the light beams from a light source to the detector, wherein the detector is embodied to detect the light beams in the form of a spectrum, wherein the method comprises steps as follows:
providing an optical model, which describes the beam path and comprises the optical components as well as their positions and orientations,
establishing a quality function, which comprises at least one quality criterion of the beam path, wherein the quality function is embodied to calculate a quality measure based on the optical model,
providing a position of the aperture diaphragm and a maximum area of the aperture in the optical model, wherein the maximum area is composed of a plurality of subapertures, calculating a quality measure for each subaperture by means of the quality function, and
determining the aperture geometry based on the calculated quality measures of the subapertures.

The method of the present disclosure enables, thus, an adapting of the aperture geometry to the beam path in the spectrometer. For such purpose, firstly, an optical model is provided, in which position and orientation of the optical components are specified and the beam path of the light beams is described. In the optical model, also an area shape of the optical components can be specified. The optical model can comprise a mathematical description of the positions and orientations of the optical components and be embodied, based on that, to calculate the beam path. Additionally, a quality function is created, which serves for calculating a quality measure. The quality measure is calculated based on the optical model.

The quality function can be embodied to apply the optical model for calculating the quality measure. The quality function can calculate the at least one quality measure based on the optical model taking into consideration the at least one quality criterion. In such case, the quality function can be embodied to check, to what extent the optical model, or the beam path, fulfills the at least one quality criterion, and, based on such testing, to calculate the quality measure. The quality function is especially embodied in such a manner that lower values of the calculated quality measure mean a greater fulfillment of the at least one quality criterion, while higher values of the calculated quality measure mean a lower fulfillment of the at least one quality criterion. The quality function can also be embodied in such a manner that greater values of the calculated quality measure mean a greater fulfillment of the at least one quality criterion. The at least one quality criterion can describe a spectrometer characteristic, or a spectrometer property. Especially, selected as the at least one quality criterion is a spectrometer characteristic having a large influence on the dimensions of the spectrometer or on the spectrum.

In another step, the position of the aperture diaphragm and the maximum area of the aperture are provided in the optical model. The maximum area of the aperture can be specified based on certain aperture geometries, based on the light throughput and/or based on other criteria. The maximum area is especially an area which the aperture should maximally cover. The maximum area is especially planar. Also a shape of the maximum area can be specified; especially the shape of the maximum area can be round, elliptical or rectangular. The maximum area is composed of a plurality of subapertures. The maximum area has especially a specified area content. The maximum area is especially selected at least sufficiently large that all light beams, which reach the detector, pass through the maximum area.

Preferably, the subapertures have each the same area content. The area content of the subapertures can, however, also differ from one another. Any subaperture shape can be selected. For example, a rectangular or square shape of the subapertures can be specified. By means of the quality function, a quality measure is calculated for each subaperture. Based on the calculated quality measures, it becomes evident to what extent the subapertures fulfill the at least one quality criterion. For example, in some subapertures undesired light beams can occur, arising, for example, from reflections. In other cases, the light beams can act negatively on the spectrum and therewith, in given cases, also affect the calculated quality measure negatively. The aperture geometry is determined based on the quality measures for the subapertures. Especially, a plurality, i.e. two or more, subapertures are selected based on their quality measures, and, based on the selected subapertures, the aperture geometry is formed. The selecting of the subapertures can occur iteratively, especially when the calculated quality measures of the subapertures are mathematically not independent of one another.

In a further development, the determining of the aperture geometry based on the quality measures of the subapertures comprises steps as follows:
providing an area content which the aperture geometry should have,
forming a plurality of groups of subapertures whose area contents correspond in total to the specified area content,
forming the sum of the calculated quality measures for each group of subapertures,
selecting that group of subapertures whose sum of the calculated quality measures has the smallest value, and
forming the aperture geometry based on the selected group of subapertures.

The provided area content can be determined, for example, according to a desired geometric light throughput. It is, however, also possible to apply in the optical model at the location of the aperture diaphragm firstly an auxiliary aperture diaphragm which has a conventional aperture geometry, and to optimize the beam path and/or the optical components by means of the auxiliary aperture diaphragm in order, for example, to achieve a desired geometric light throughput. In order to retain this desired geometric light throughput, advantageously, the area content of the auxiliary aperture diaphragm is specified as the area content which the aperture geometry should have. For the method of the present disclosure, the auxiliary aperture diaphragm is then removed from the optical model.

Then a plurality, i.e. two or more, groups of subapertures is formed. The sum of the area contents of the subapertures of each group corresponds, in such case, to the specified area content. Furthermore, the sum of the calculated quality measures of the subapertures associated with each group is formed for each group of subapertures. In a next step, then that group of subapertures is selected whose sum of the calculated quality measures has the smallest value, and, based on the selected group of subapertures, finally, the aperture geometry is formed. As above already described, the quality function is, as a rule, defined in such a manner that lower values of the calculated quality measure mean a greater fulfillment of the at least one quality criterion. In the case in which the quality function is embodied in such a manner that greater values of the calculated quality measure mean a greater fulfillment of the at least one quality criterion, then in this embodiment that group of subapertures should be selected, whose sum of the calculated quality measures has the maximum value.

In an alternative further development, the determining of the aperture geometry based on the quality measures of the subapertures includes the following step:
forming the aperture geometry from those subapertures whose sum of the calculated quality measures subceeds a specified limit value.

In this case, a limit value for the calculated quality measures is specified and those subapertures are selected whose sum of the calculated quality measures subceeds the specified limit value. As already described above, the quality function is, as a rule, defined in such a manner that lower values of the calculated quality measure mean a greater fulfillment of the at least one quality criterion. Accordingly, those subapertures are selected, whose calculated quality measures in total subceed the specified limit value. In the case in which the quality function is embodied in such a manner that greater values of the calculated quality measure mean a greater fulfillment of the at least one quality criterion, then, in this embodiment, those subapertures are selected, whose calculated quality measure in total exceeds the specified limit value. The aperture geometry is then formed from the selected subapertures.

In a further development, the determined aperture geometry is a single aperture or an aperture composed of a plurality of mutually spaced subregions. The determined aperture geometry can, thus, be a monolithic area or a plurality of, i.e. two or more, areas separated from one another.

In an embodiment, for each subaperture a quality measure for that part of the light beams passing through the subaperture is calculated by means of the quality function. The part of the light beams passing through the subaperture, can vary widely. Thus, it can be, that some subapertures are traveled through by only a few or a single light beam, while others are traveled through by many or a high number of light beams. Since the beam path of the optical model is known, it can be detected based on the optical model, which light beams travel through which subaperture. As a result, it is possible by means of the quality function to calculate a quality measure for that part of the light beams which pass through any given subaperture.

In an additional embodiment, a banana-shaped aperture geometry is determined. Also, other nonconventional aperture geometries are determinable, such as, for example, trapezoid-or diamond shaped aperture geometries. It is also possible that a conventional aperture geometry, such as, for example, a circular, elliptical or rectangular aperture geometry, is determined, which is then especially well adapted to the light beams of the beam path. Especially for spectrometers having a complex construction of many optical components, however, as a rule, non-conventional aperture geometries are obtained.

Another embodiment provides that used as the at least one quality criterion is a quality criterion for a spectrometer-geometry, a quality criterion for image defects and/or a quality criterion for parasitic beam characteristics. The quality criterion for the spectrometer-geometry concerns especially the dimensions of the spectrometer. In such case, it can be of advantage, for example, to apply a spectrometer with small dimensions or having a specified extent in one direction. The quality criterion for image defects concerns especially image defects in the spectrum. Desirable in such case is to have as few image defects as possible. The quality criterion for parasitic beam characteristics concerns especially undesired light beams, which affect the spectrum negatively and come, for example, from reflections on optical components.

In a further development, the quality function comprises multiple quality criteria of the beam path, wherein the quality function calculates a quality measure based on the optical model and specified weightings of the quality criteria. The expression “multiple quality criteria” means that two or more quality criteria are used. Thus, the quality function can describe a first quality criterion for the spectrometer-geometry, a second quality criterion for image defects and a third quality criterion for parasitic beam characteristics. The multiple quality criteria can be combined by means of an “AND” operation in the quality function.

In an embodiment, the aperture diaphragm is arranged in the beam path before or behind a slit of the spectrometer. The slit can be an entrance slit of the spectrometer. Preferably, the aperture diaphragm is arranged neighboring the slit. An optical component, for example, a mirror, can be arranged between the slit and the aperture diaphragm. Preferably, the aperture diaphragm is arranged before the slit in the beam path to the detector.

In a further development, the aperture diaphragm is arranged at a position of the beam path where the light beams are spectrally separated or not spectrally separated. If the aperture diaphragm, for example, neighbors the slit, then, as a rule, the light beams are not yet spectrally separated at the aperture diaphragm. If the aperture diaphragm is arranged, for example, after a grating or nearer to the detector, then the light beams can be spectrally separated at the location of the aperture diaphragm. In this case, due the separating of the light beams into the different wavelengths, it is possible, in given cases, to achieve an especially good adapting of the aperture geometry as regards image defects.

Advantageously used as optical components are mirrors, filters, gratings, prisms and/or lenses.

In a further development, one of the optical components is an echelle-grating.

Preferably used as spectrometer is an ICP-OES device or an AAS device. ICP-OES stands for “inductively coupled plasma optical emission spectroscopy”. The ICP-OES device is an emission spectroscopy in the case of which an inductively coupled plasma is applied for producing excited atoms and ions that emit electromagnetic radiation with wavelengths characteristic for a certain element. AAS stands for atomic absorption spectroscopy. AAS is a spectro analytic method for quantitative determining of chemical elements using free atoms in the gaseous state. Atomic absorption spectroscopy is based on the absorption of light by free atoms and molecules. Both ICP-OES as well as also AAS devices frequently have a large number of optical components and, especially, an echelle-grating. Both devices serve for analysis of samples as regards their atomic composition. The proposed method is especially advantageous for both devices, since, because of the complex beam path, conventional aperture geometries do not, as a rule, provide optimum results as regards the at least one quality criterion.

The object is achieved, furthermore, by a method for producing an aperture diaphragm having an aperture, whose aperture geometry is adapted to a beam path of light beams in a spectrometer, wherein the spectrometer comprises the aperture diaphragm, a plurality of optical components and a detector, wherein the optical components are arranged and embodied in such a manner that they lead the beam path of the light beams from a light source to the detector, wherein the detector is embodied to detect the light beams in the form of a spectrum, wherein the method comprises steps as follows:
determining the aperture geometry according to one of the preceding embodiments,
providing a blank for the aperture diaphragm,
removing at least one region of the blank corresponding to the determined aperture geometry.

By means of the method of the present disclosure, thus, an aperture diaphragm is obtained, which has the determined aperture geometry. The blank can be, for example, a metal—or plastic part. The removing of the at least one region of the blank, which corresponds to the determined aperture geometry, can occur by means of milling or cutting. Optionally, the blank can be processed before or after the step of removing in such a manner that it has a black surface. Alternatively, the aperture diaphragm can be made by means of an additive production method, such as, for example, 3D printing.

The object of the present disclosure is further achieved by a spectrometer comprising a plurality of optical components, a detector and an aperture diaphragm and produced according to the method of the preceding embodiment, wherein the optical components are arranged and embodied in such a manner that they lead the beam path of the light beams from a light source to the detector, wherein the detector is embodied to detect the light beams in the form of a spectrum.

In the spectrometer of the present disclosure, thus, an aperture diaphragm is applied, whose aperture geometry is adapted to the beam path in the spectrometer.

### BRIEF DESCRIPTION OF THE DRAWINGS

The present disclosure will now be explained in greater detail based on the appended drawing, the FIGS. 1-4 of which show as follows:

FIG. 1 shows a schematic view of a spectrometer of the present disclosure.

FIG. 2 shows a schematic view of the maximum area, the subapertures and the determined aperture geometry.

FIG. 3 shows a schematic view of the blank and the aperture diaphragm.

FIG. 4 shows another view of an aperture diaphragm produced according to the present disclosure.

### DETAILED DESCRIPTION

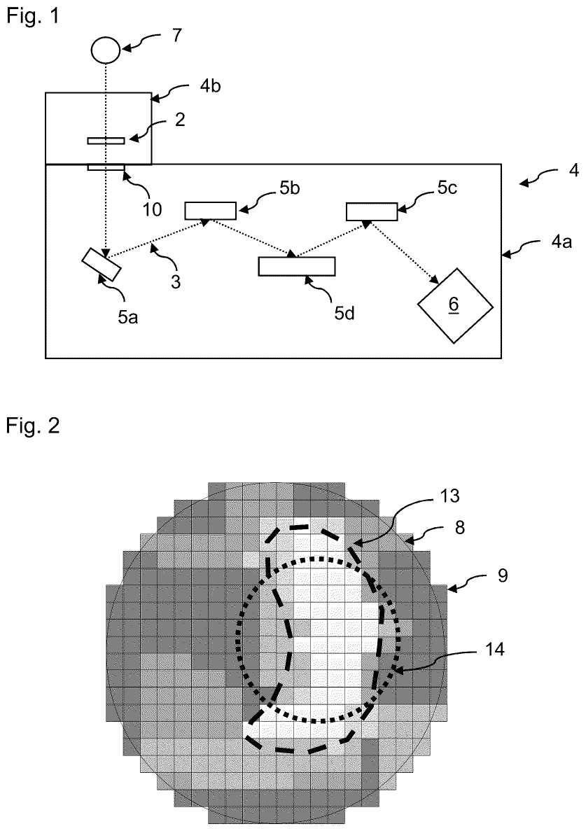

FIG. 1 shows a schematic view of the spectrometer 4 of the present disclosure. Spectrometer 4 comprises a plurality of optical components, an aperture diaphragm 2 and a detector 6. The optical components 5a-5d are arranged and embodied in such a manner that they lead the beam path 3 of the light beams from a light source 7 to the detector 6. The detector 6 is embodied to detect the light beams in the form of a spectrum. Spectrometer 4 can be divided into a number of sections, for example, a main region 4a and a front region 4b. Front region 4b can be arranged between the light source 7 and the main region 4a. Front region 4b can be embodied to collect the light beams emitted from the light source 7 and to lead them to the main region 4a. The front region 4b can have other optical components, such as, for example, an entrance opening or mirror or lenses, which are not shown. Spectrometer 4 can have a slit 10. Slit 10 can be arranged between the main region 4a and the front region 4b. Aperture diaphragm 2 can be arranged neighboring the slit 10. Optical components 5a,5b,5c can be mirrors. Optical component 5d is, by way of example, embodied as an echelle-grating. Other optical components can be filters, prisms and/or lenses. Spectrometer 4 can be an ICP-OES device or an AAS device.

FIG. 2 shows, by way of example, how the aperture geometry is determined based on the quality measures of the calculated subapertures 9. As already described, in the system of the present disclosure, firstly, an optical model is provided which describes the beam path 3. Additionally, a quality function is created having at least one quality criterion. Furthermore, a position of the aperture diaphragm 2 and a maximum area 8 of the aperture 1 are provided in the optical model. FIG. 2 shows such a maximum area 8 in the form of a circle as approximated by the layout of the small squares. The maximum area 8 can also have another shape or size. Maximum area 8 is composed of a plurality of subapertures 9. In the illustrated example, the subapertures 9 are embodied as the small squares. Subapertures 9 can, however, also have another shape. Also, all of the subapertures 9 do not have to have the same shape and size.

In a next step, a quality measure is calculated for each subaperture 9 by means of the quality function. The calculated quality measure is shown as grayscale in FIG. 2. In such case, lighter areas have a lower value of the calculated quality measure than darker areas. Based on the calculated quality measures of the subapertures 9, finally, the aperture geometry is determined. The dashed line 13 shows schematically how the determined aperture geometry can look.

As is observable based on the view in FIG. 2, there are a large number of subapertures having a small quality measure, i.e. a light area, wherein the arrangement of these subapertures conforms to no conventional aperture geometry. The dotted line 14 shows how such a conventional, circular aperture geometry not adapted by means of the method of the present disclosure can look. Significantly in the case of application of the dotted circle shaped aperture geometry, some subapertures 9 of small quality measure lie outside of the aperture 1 and subapertures 9 having a significantly greater quality measure lie within the aperture. Thus, light beams reach the detector 6, which affect the spectrum or the spectrometer negatively, since they bring about image defects, for example. Conversely, some light beams which have a positive effect are blocked by the aperture diaphragm and, thus, do not reach the detector 6. In contrast, in the case of the determined aperture geometry, which is shown by the dashed line 13, possibly all subapertures 9 having a small calculated quality measure are captured by the aperture geometry. In the illustrated example, thus, a banana-shaped aperture geometry is obtained. The aperture geometry is shown in the example of FIG. 2 as a single aperture. It is, however, also possible that an aperture composed of a plurality of mutually spaced parts is obtained, such as shown, by way of example, in FIG. 4.

The determining of aperture geometry based on the calculated quality measures can occur in different ways. For example, a limit value can be specified and the aperture geometry formed from all subapertures 9, whose sum of the calculated quality measures subceeds the limit value. Alternatively, also an area content can be specified, which the aperture geometry should have, and a plurality of groups of subapertures 9 formed, whose sum of area contents corresponds to the specified area content. Then, the sum of the calculated quality measures for each group of subapertures can be calculated and the group of subapertures with the smallest value of the sum selected. The aperture geometry is then formed based on the selected group.

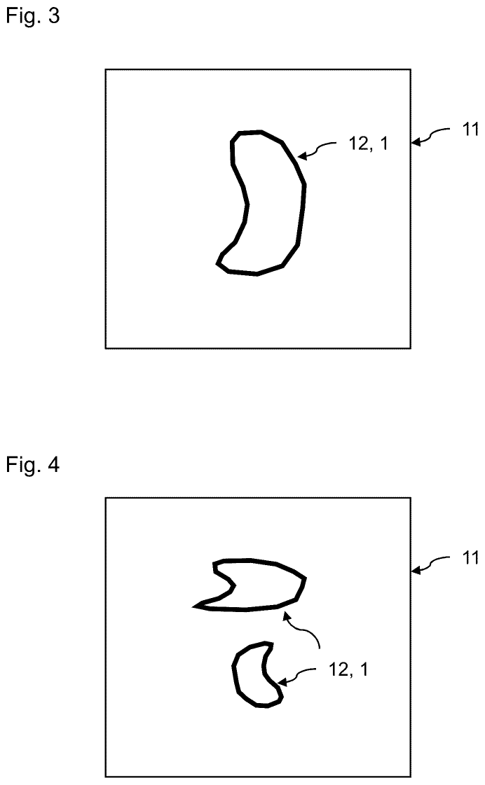

The aperture geometry determined in such a way can be used for producing an aperture diaphragm 2. For such purpose, a blank 11 is provided (compare FIG. 3), in the case of which at least one region 12 is removed, whose shape corresponds to the determined aperture geometry. The at least one region 12 forms then the aperture 1 of the aperture diaphragm 2.

1. A method for adapting an aperture geometry of an aperture of an aperture diaphragm to a beam path of light beams in a spectrometer, wherein the spectrometer includes the aperture diaphragm, a plurality of optical components, and a detector, wherein the optical components are arranged and embodied in such a manner that they lead the beam path of the light beams from a light source to the detector, wherein the detector is embodied to detect the light beams in the form of a spectrum, the method comprising:
providing an optical model that describes the beam path and includes the optical components as well as their positions and orientations;
establishing a quality function that includes at least one quality criterion of the beam path, wherein the quality function is embodied to calculate a quality measure based on the optical model;
providing a position of the aperture diaphragm and a maximum area of the aperture in the optical model, wherein the maximum area is composed of a plurality of subapertures;
calculating a quality measure for each subaperture by means of the quality function; and
determining the aperture geometry based on the calculated quality measures of the subapertures.

2. The method as claimed in claim 1,
wherein the determining of the aperture geometry based on the quality measures of the subapertures comprises steps as follows:
specifying an area content that the aperture geometry should have;
forming a plurality of groups of subapertures whose area contents correspond in total to the specified area content;
forming the sum of the calculated quality measures for each group of subapertures;
selecting that group of subapertures whose sum of the calculated quality measures has the smallest value; and
forming the aperture geometry based on the selected group of subapertures.

3. The method as claimed in claim 1,
wherein the determining the aperture geometry based on the quality measures of the subapertures includes the following step:
forming the aperture geometry from those subapertures whose sum of the calculated quality measures subceeds a specified limit value.

4. The method as claimed in claim 1,
wherein the determined aperture geometry is a single aperture or an aperture composed of a plurality of mutually spaced subregions.

5. The method as claimed in claim 1,
wherein, for each subaperture, a quality measure for that part of the light beams passing through the subaperture is calculated via the quality function.

6. The method as claimed in claim 1,
wherein a banana shaped aperture geometry is determined.

7. The method as claimed in claim 1,
wherein used as the at least one quality criterion is a quality criterion for a spectrometer geometry, a quality criterion for image defects, and/or a quality criterion for parasitic beam characteristics.

8. The method as claimed in claim 1,
wherein the quality function includes multiple quality criteria of the beam path, wherein the quality function calculates a quality measure based on the optical model and a specified weighting of the quality criteria.

9. The method as claimed in claim 1,
wherein the aperture diaphragm is arranged in the beam path before or behind a slit of the spectrometer.

10. The method as claimed in claim 1,
wherein the aperture diaphragm is arranged at a position of the beam path where the light beams are spectrally separated or not spectrally separated.

11. The method as claimed in claim 1,
wherein used as optical components are mirrors, filters, gratings, prisms, and/or lenses.

12. The method as claimed in claim 11,
wherein one of the optical components is an echelle-grating.

13. The method as claimed in claim 1,
wherein used as the spectrometer is an inductively coupled plasma optical emission spectroscopy (ICP-OES) device or an atomic absorption spectroscopy (AAS) device.

14. A method for producing an aperture diaphragm with an aperture whose aperture geometry is adapted to a beam path of light beams in a spectrometer, wherein the spectrometer includes the aperture diaphragm, a plurality of optical components, and a detector, wherein the optical components are arranged and embodied in such a manner that they lead the beam path of the light beams from a light source to the detector, wherein the detector is embodied to detect the light beams in the form of a spectrum, the method comprising:
determining the aperture geometry by:
providing an optical model that describes the beam path and includes the optical components as well as their positions and orientations;
establishing a quality function that includes at least one quality criterion of the beam path, wherein the quality function is embodied to calculate a quality measure based on the optical model;
providing a position of the aperture diaphragm and a maximum area of the aperture in the optical model, wherein the maximum area is composed of a plurality of subapertures;
calculating a quality measure for each subaperture by means of the quality function; and
determining the aperture geometry based on the calculated quality measures of the subapertures;
providing a blank for the aperture diaphragm; and
removing at least one region of the blank corresponding to the determined aperture geometry.

15. A spectrometer comprising a plurality of optical components, a detector, and an aperture diaphragm and produced according to the method as claimed in claim 14, wherein the optical components are arranged and embodied in such a manner that they lead the beam path of the light beam from a light source to the detector, wherein the detector is embodied to detect the light beam in the form of a spectrum.
